(19) United States
(12) Patent Application Publication
(10) Pub. No.: US 2011/0119949 A1
(43) Pub. Date: May 26, 2011

(54) CONTROLLABLE CURING SYSTEMS AND METHODS INCLUDING AN LED SOURCE

(75) Inventors: Andrew Kites, Brighton, MA (US); Douglas Lawson, Westford, MA (US)

(73) Assignee: Luminus Devices, Inc., Billerica, MA (US)

(21) Appl. No.: 12/624,813

(22) Filed: Nov. 24, 2009

(51) Int. Cl. F26B 3/28; G21K 5/02; F26B 3/34; F26B 7/00

(52) U.S. Cl. 34/275; 250/492.1; 34/427

(57) ABSTRACT

Curing systems and related methods are described herein. The curing systems include an LED source.

### BACKGROUND OF THE INVENTION

1. Field of the Invention

The present embodiments relate generally to curing systems and methods and more particularly to curing systems including an LED source.

2. Description of the Prior Art

A light-emitting diode (LED) can often provide light in a more efficient manner than an incandescent light source and/or a fluorescent light source. The relatively high power efficiency associated with LEDs has created an interest in using LEDs to displace conventional light sources in a variety of lighting applications. For example, in some instances LEDs are being used as traffic lights, to illuminate displays systems and so forth. Furthermore, LEDs are being incorporated into residential and commercial lighting applications displacing less efficient and less durable light devices. Many technological advances have led to the development of high power LEDs by increasing the amount of light emission from such devices.

Many curing systems currently use mercury arc lamps as the radiation source to cure various products such as inks, laminates, paints and so forth. These mercury arc lamps generally produce a broad band of light including several peaks in the ultraviolet region of the electromagnetic spectrum. Because of the broad spectrum, filters are used at times to block particular wavelengths so as to not interfere with a particular curing process. Mechanical shutters are also often used to limit the exposure time with curing systems using mercury arc lamps because of the difficulty in creating an instant on and off system. Other concerns surrounding mercury arc lamps include utilizing the output of the lamp in a concentrated means because of etendue limits.

### SUMMARY OF THE INVENTION

A curing system is described herein that can individually control factors in the curing process such as the power, intensity (defined by area and angle of emission), duration, and type of light (wavelength) emitted during the curing process while increasing efficiency, longevity, and durability of the system. Controlling these factors allow for a more precise as well as tunable cure.

One embodiment provides an LED source that emits a desired wavelength, with a controller that controls the amount of time, power, area, and angle of the emission onto a curable product, wherein the system and method is devoid of using optical filters, mechanical shutters, and wherein some embodiments are devoid of optical reflectors and lenses.

In one embodiment, a method for curing is provided. The method comprises providing at least one LED source capable of emitting at least one discrete wavelength. The method further comprises controlling the individual power and wavelength emitted by the LED source(s) and exposing a curable substance to the controlled emission of the LED source(s), wherein a desired curing process is achieved.

In one embodiment, a system for curing a product is provided. The system comprises at least one LED source emitting radiation having a first wavelength; and a controller having the capability to control the power and wavelength of the emission from the LED source(s).

In one embodiment, a system for curing a product is provided. The system comprises at least one LED source emitting radiation having a first wavelength and a controller having the capability to control the power and wavelength of the emission from the LED source(s). The system further comprises an optical system guiding the emitted radiation from the LED source to a curable product.

Some embodiments may include multiple LEDs arranged in an array wherein all of the LEDs emit the same wavelength. Additionally, multiple arrays may be arranged in a single system wherein each array emits a separate and distinct wavelength from the other arrays.

Some embodiments may include a module for each LED source that is positionable with respect to the curable product.

Some embodiments may include a programmable interface that controls the time (duration), power (as defined as a function of energy input and s wavelength), intensity (as defined as a function of area and angle), and type of light (wavelength) emitted by the LED sources. This particular embodiment may also draw upon a database of characteristics associated with particular curable substances and photo initiators. Such a database may be comprised of a number of wavelengths, intensities, and power outputs that correlate to the various responsive behaviors at various curing stages of a particular resin, epoxy, plastic, paint, photo initiator, or other composition on both a macro and micro scale.

Other aspects, embodiments and features of the invention will become apparent from the following detailed description of the invention when considered in conjunction with the accompanying figures. The accompanying figures are schematic and are not intended to be drawn to scale. In the figures, each identical or substantially similar component that is illustrated in various figures is represented by a single numeral or notation.

For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

FIG. 1 is a schematic of a curing system.

FIG. 2 is a representative graph of the output of a curing system.

FIG. 3 is schematic of a curing system with an interface.

FIG. 4 is a representative graph of a mercury arc lamp.

FIG. 5 is a representative graph of another mercury arc lamp compared to a xenon arc lamp.

FIG. 6 illustrates an LED die.

### DETAILED DESCRIPTION OF THE PREFERRED EMBODIMENT

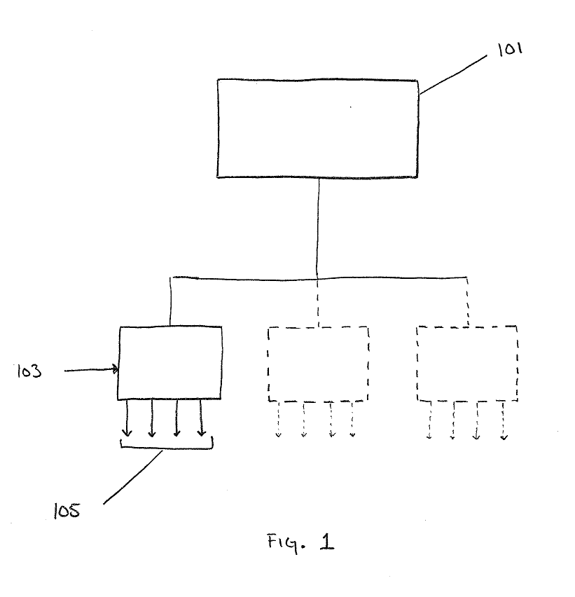

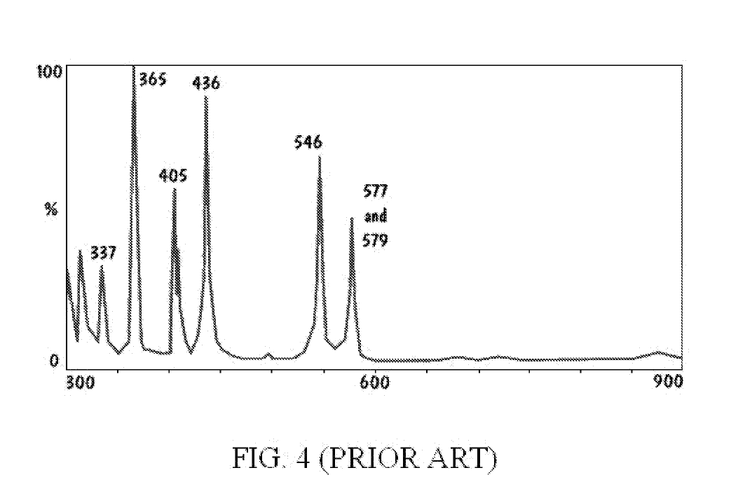

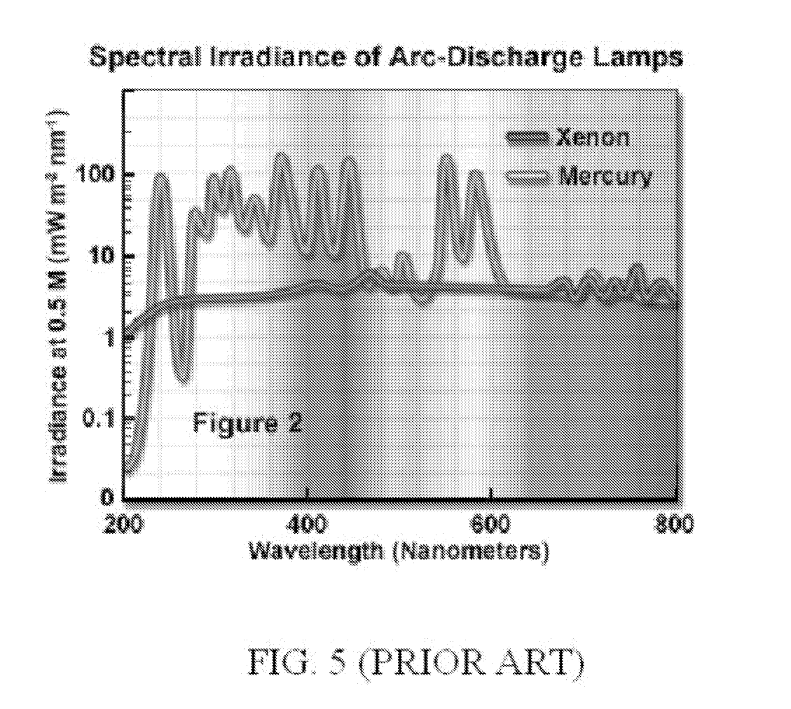

One or more embodiments presented herein include a controllable curing system. FIG. 1 is a schematic of an embodiment of a curing system including an LED 103, and controller 101. LED 103 is capable of emitting radiation 105 having a discrete wavelength or single peak according to the electromagnetic spectrum. The bandwidth of such a single peak may extend up to 20-30 nanometers; however, the majority of the power generally lies within an approximate 4 nanometer band wherein the maximum power output is at a discrete wavelength or single peak in the profile. This may be classified as narrow band emission to those familiar in the LED art. By contrast a mercury arc lamp's radiation emission spectrum consists of multiple peaks across a broader spectrum (See FIGS. 4-5). The radiation emission emitted by mercury arc lamps and other similar lamps are not in single bands or peaks requiring additional parts to focus and utilize the desired emission bands or peaks.

The extra, not-needed, or even counterproductive emission points or wavelengths along the broader spectrum often require a filtering system. One embodiment allows for the curing system to be devoid of any filters, thus creating a simpler set up and allowing for a more focused approach in curing systems. Over the years curing has often been referred to as a ‘black art’ because it has not always been known which particular wavelengths are productive and responsive. This embodiment includes fine tuning the each wavelength, emitted, the duration of each emission, intensity, and power outputs as controlled by controller 101, thus allowing for a curing system enabling one to cure products to a desired consistency.

This embodiment will also allow for the further development, classification, and clarification regarding chemicals, photo initiators, and other combinations responding to a particular peak or narrow band of radiation because of the embodiment's flexibility. Additionally, some materials may be responsive earlier when a lower intensity or power output is reached prior to responsiveness of other materials at higher intensities and power outputs. Some materials may prefer a lower power output over a longer duration for a different curing process outcome. As shown, a myriad of combinations are possible with the individual controllability of the mentioned factors. Thus, aiding experimentation to create more tailored and product responsive materials, such as photo initiators for the curing industry.

Curing, as a part of polymer chemistry, generally refers to the cross-linking of polymer chains brought about by ultraviolet radiation, heat, or adding chemical additives. This cross-linking of polymer chains causes the product to harden and become less viscous as the polymer chains form a single solidified product. For this application, curing may also refer to partial curing wherein the viscosity of a curable product is changed. For example, a desired application may involve focusing a specified wavelength for a short period of time to some paint in order to thicken the paint to a desirable consistency prior to applying it to another application.

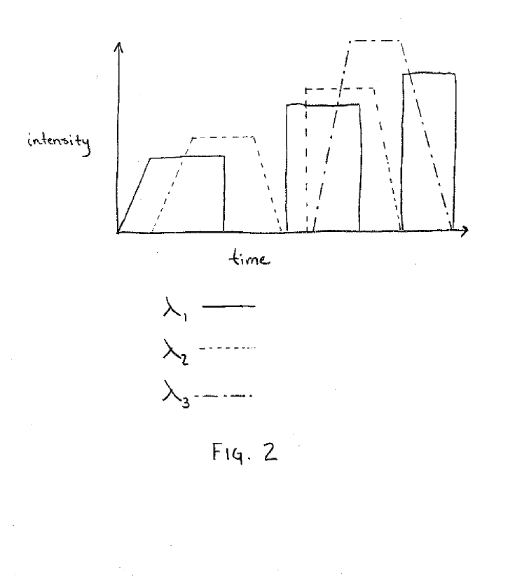

As previously discussed, the ability to tune a curing system that is responsive to a wider range of materials is illustrated in FIG. 2 where a is representative graph of the individual controllability of the time, intensity, and wavelength of a curing system is shown. In this particular embodiment, FIG. 2 shows three wavelengths λ₁, λ₂, λ₃, as distinct wavelengths or single peaks on graph illustrating time across the horizontal axis and intensity across the vertical axis. Though not shown on the graph in FIG. 2, intensity could be replaced by power along the vertical axis, showing similar controllability of the aforementioned factors when curing. It can be seen that each single peak comes on during a different time in the process and has a varying intensity (and/or power—not shown) even to extent of being completely off during a portion of this particular process. This ability allows for specialized targeting. An example may include curing a label on a bottle or can that has multiple colors. One wavelength may respond more positively to a particular pigment in the label. So as to bring that particular color out more vividly or brilliantly that peak wavelength is turned on and possibly at a high intensity (or power) allowing for those particular cross polymers to quickly link, then shortly after another wavelength or wavelengths are emitted to continue the curing process to its desired state.

One of the other advantages of such a system is the ability to instantly turn off and on each peak wavelength as desired in the curing process. Instantly on and off refers to less than a microsecond response time even down into the nanoseconds of response time. The system can also be pulsed with each pulse having a duration of less than a microsecond. Such a system may be seen as extremely efficient over a mercury arc lamp system that is constantly on because warm up and cool down times are not instantaneous and are required to conserve lamp life. For larger applications such as floor laminates a number of LEDS may be combined to form an array. This array may contain LEDs that all emit the same peak wavelength or they may each have individual and discrete wavelengths. Some embodiments include using multiple arrays to achieve sufficient illumination and intensity over larger surface areas.

Another aspect of an embodiment includes reactive curing response. For example, if a particular laminate was not mixed thoroughly or evenly, thicker in certain regions and so forth, the curing system can incorporate sensors known in the field to detect such inadequate curing and automatically adjust the power, intensity, duration and/or peak wavelength to compensate for such inconsistencies. Such information to compensate may be stored in a database listing various properties to curable substances including reaction times, intensity levels, power output and peak wavelengths.

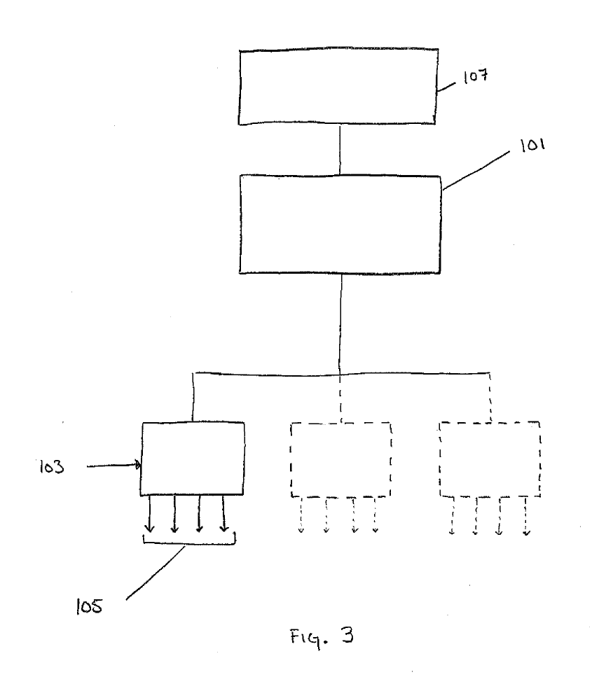

FIG. 3 is schematic of a curing system with a programmable interface 107. This programmable interface allows for ‘recipes’ to be created, stored, executed and so forth. It interacts with controller 101, which may consist of a computer having microcode that drives the individual LEDs.

Another embodiment includes the use of larger LEDs to minimize and in some instances eliminate the use of additional optics. These LEDs have surface emitting areas larger than 1 mm², (e.g. larger than 3 mm², larger than 9 mm²). In some instances the radiation emitted is uniform at all angles or Lambertian. Larger LEDs allow for a single LED to be placed in a single module that is positionable with respect to the curable material. The module may be mechanized and automated or simple adjustable with mounting mechanisms well known in the art. The larger surface emitting LEDs also allow for greater power output of radiation or light.

In some embodiments a single LED may also be combined with a light guide that either further focuses the emission into a point source or further spreads the radiation uniformly onto curable area. One example may include a paint spray gun where the LED source is attached away from the spray gun similar to the paint being located at another source from the spray gun. The light guide like the paint tube channels the light and directs at the radiation emission at the same time paint is emitted by the spray gun. The light guide may be connected to an array of LEDs at the opposite end of the spray gun wherein the LEDs each have the same or distinct peak wavelengths. This LED or array may be also connected to a controller allowing for the desired curing application as in the instance of using certain intensities, power levels, and peak wavelengths with one coat of paint and others with another coat.

In some embodiments other optics may be used to manipulate the intensity output of the emission either manually or automatically through a single lens, series of lenses, parabolic reflectors, light guides, and other optical components known in the art.

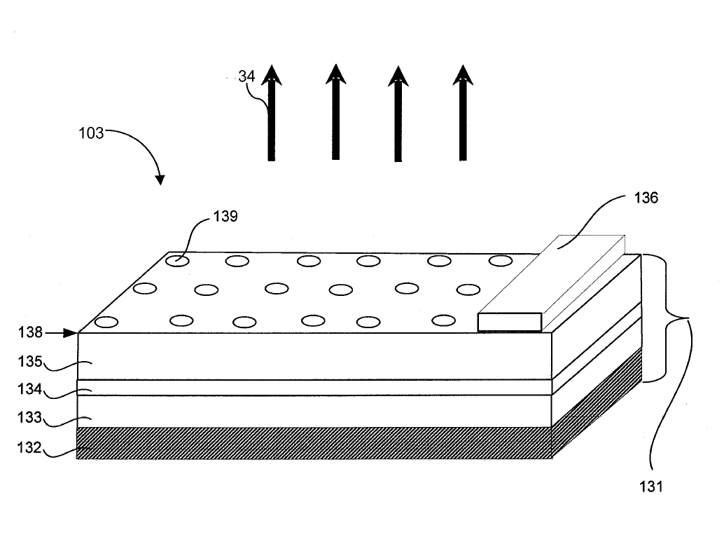

FIG. 6 illustrates an LED die that may be the radiation emission generating component of the curing system, in accordance with one embodiment. It should also be understood that various embodiments presented herein can also be applied to other light-emitting devices, such as laser diodes, and LEDs having different structures. The LED 103 shown in FIG. 6 comprises a multi-layer stack 131 that may be controlled by controller 101 as shown in FIG. 1. The multi-layer stack 131 can include an active region 134 which is formed between n-doped layer(s) 135 and p-doped layer (s) 133. The stack can also include an electrically conductive layer 132 which may serve as a p-side contact, which can also serve as an optically reflective layer. An n-side contact pad 136 is disposed on layer 135. It should be appreciated that the LED is not limited to the configuration shown in FIG. 6, for example, the n-doped and p-doped sides may be interchanged so as to form a LED having a p-doped region in contact with the contact pad 136 and an n-doped region in contact with layer 132. As described further below, electrical potential may be applied to the contact pads which can result in light generation within active region 134 and emission of at least some of the light generated through an emission surface 138. As described further below, openings 139 may be defined in a light-emitting interface (e.g., emission surface 138) to form a pattern that can influence light emission characteristics, such as light extraction and/or light collimation. It should be understood that other modifications can be made to the representative LED structure presented, and that embodiments are not limited in this respect.

The active region of an LED can include one or more quantum wells surrounded by barrier layers. The quantum well structure may be defined by a semiconductor material layer (e.g., in a single quantum well), or more than one semiconductor material layers (e.g., in multiple quantum wells), with a smaller electronic band gap as compared to the barrier layers. Suitable semiconductor material layers for the quantum well structures can include InGaN, AlGaN, GaN and combinations of these layers (e.g., alternating InGaN/GaN layers, where a GaN layer serves as a barrier layer). In general, LEDs can include an active region comprising one or more semiconductors materials, including III-V semiconductors (e.g., GaAs, AlGaAs, AlGaP, GaP, GaAsP, InGaAs, InAs, InP, GaN, InGaN, InGaAlP, AlGaN, as well as combinations and alloys thereof), II-VI semiconductors (e.g., ZnSe, CdSe, ZnCdSe, ZnTe, ZnTeSe, ZnS, ZnSSe, as is well as combinations and alloys thereof), and/or other semiconductors. Other light-emitting materials are possible such as quantum dots or organic light-emission layers.

The n-doped layer(s) 135 can include a silicondoped GaN layer (e.g., having a thickness of about 4000 nm thick) and/or the p-doped layer(s) 133 include a magnesiumdoped GaN layer (e.g., having a thickness of about 40 nm thick). The electrically conductive layer 132 may be a silver layer (e.g., having a thickness of about 100 nm), which may also serve as a reflective layer (e.g., that reflects upwards any downward propagating light generated by the active region 134). Furthermore, although not shown, other layers may also be included in the LED; for example, an AIGaN layer may be disposed between the active region 134 and the p-doped layer(s) 133. It should be understood that compositions other than those described herein may also be suitable for the layers of the LED.

As a result of openings 139, the LED can have a dielectric function that varies spatially according to a pattern which can influence the extraction efficiency and/or collimation of light emitted by the LED. In the illustrative LED 103, the pattern is formed of openings, but it should be appreciated that the variation of the dielectric function at an interface need not necessarily result from openings. Any suitable way of producing a variation in dielectric function according to a pattern may be used. For example, the pattern may be formed by varying the composition of layer 135 and/or emission surface 138. The pattern may be periodic (e.g., having a simple repeat cell, or having a complex repeat super-cell), periodic with de-tuning, or non-periodic. As referred to herein, a complex periodic pattern is a pattern that has more than one feature in each unit cell that repeats in a periodic fashion. Examples of complex periodic patterns include honeycomb patterns, honeycomb base patterns, (2×2) base patterns, ring patterns, and Archimedean patterns.

In some embodiments, a complex periodic pattern can have certain openings with one diameter and other openings with a smaller diameter. As referred to herein, a non-periodic pattern is a pattern that has no translational symmetry over a unit cell that has a length that is at least 50 times the peak wavelength of light generated by active region 134. Examples of non-periodic patterns include aperiodic patterns, quasi-crystalline patterns, Robinson is patterns, and Amman patterns.

In certain embodiments, an interface of a lightemitting device is patterned with openings which can form a photonic lattice. Suitable LEDs having a dielectric function that varies spatially (e.g., a photonic lattice) have been described in, for example, U.S. Pat. No. 6,831,302 B2, entitled “Light Emitting Devices with Improved Extraction Efficiency,” filed on Nov. 26, 2003, which is herein incorporated by reference in its entirety. A high extraction efficiency for an LED implies a high power of the emitted light and hence high brightness which may be desirable in various optical systems.

It should also be understood that other patterns are also possible, including a pattern that conforms to a transformation of a precursor pattern according to a mathematical function, including, but not limited to an angular displacement transformation. The pattern may also include a portion of a transformed pattern, including, but not limited to, a pattern that conforms to an angular displacement transformation. The pattern can also include regions having patterns that are related to each other by a rotation. A variety of such patterns are described in U.S. patent application Ser. No. 11/370,220, entitled “Patterned Devices and Related Methods,” filed on Mar. 7, 2006, which is herein incorporated by reference in its entirety.

Light may be generated by the LED as follows. The p-side contact layer can be held at a positive potential relative to the n-side contact pad, which causes electrical current to be injected into the LED. As the electrical current passes through the active region, electrons from n-doped layer(s) can combine in the active region with holes from p-doped layer(s), which can cause the active region to generate light. The active region can contain a multitude of point dipole radiation sources that generate light with a spectrum of wavelengths characteristic of the material from which the active region is formed. For InGaN/GaN quantum wells, the spectrum of wavelengths of light generated by the light-generating region can have a peak wavelength of about 445 nanometers (nm) and a full width at half maximum (FWHM) of about 30 nm, which is perceived by human eyes as blue light. The light emitted by the LED may be influenced by any patterned interface through which light passes, whereby the pattern can be arranged so as to influence light extraction and/or collimation.

In other embodiments, the active region can generate light having a peak wavelength corresponding to ultraviolet light (e.g., having a peak wavelength of about 360-390 nm), violet light (e.g., having a peak wavelength of about 390-430 nm), blue light (e.g., having a peak wavelength of about 430-480 nm), cyan light (e.g., having a peak wavelength of about 480-500 nm), green light (e.g., having a peak wavelength of about 500 to 550 nm), yellow-green (e.g., having a peak wavelength of about 550-575 nm), yellow light (e.g., having a peak wavelength of about 575-595 nm), amber light (e.g., having a peak wavelength of about 595-605 nm), orange light (e.g., having a peak wavelength of about 605-620 nm), red light (e.g., having a peak wavelength of about 620-700 nm), and/or infrared light (e.g., having a peak wavelength of about 700-1200 nm).

In some embodiments the curing process prefers a first wavelength in the range of 400-420 nm, another wavelength in the range of 380-400, and another wavelength in the range of 360-380.

In certain embodiments, the LED may emit light having a high power. As previously described, the high power of emitted light may be a result of a pattern that influences the light extraction efficiency of the LED. For example, the light emitted by the LED may have a power output greater than 0.5 Watts (e.g., greater than 1 Watt, greater than 5 Watts, or greater than 10 Watts). In some embodiments, the light generated by a single LED has a power output of less than 100 Watts, though this should not be construed as a limitation of all embodiments. However, the power output generated by an array of LEDs may very well exceed several hundred watts. The power outptut of the light emitted from an LED can be measured by using an integrating sphere equipped with spectrometer, for example a SLM12 from Sphere Optics Lab Systems. The desired power depends, in part, on the optical system that the LED is being utilized within. For example, a display system (e.g., a LCD system) may benefit from the incorporation of high brightness LEDs which can reduce the total number of LEDs that are used to illuminate the display system.

The light generated by the LED may also have a high total power flux. As used herein, the term “total power flux” refers to the total power divided by is the emission area. In some embodiments, the total power flux is greater than 0.03 Watts/mm2, greater than 0.05 Watts/mm2, greater than 0.1 Watts/mm2, or greater than 0.2 Watts/mm2. However, it should be understood that the LEDs used in systems and methods presented herein are not limited to the above described power and power flux values.

In some embodiments, the LED may be associated with a wavelength-converting region (not shown). The wavelength-converting region may be, for example, a phosphor region. The wavelength-converting region can absorb light emitted by the light-generating region of the LED and emit light having a different wavelength than that absorbed. In this manner, LEDs can emit light of wavelength(s) (and, thus, color) that may not be readily obtainable from LEDs that do not include wavelength-converting regions.

As used herein, an LED may be an LED die, a partially packaged LED die, or a fully packaged LED die. It should be understood that an LED may include two or more LED dies associated with one another, for example a redlight emitting LED die, a green-light emitting LED die, a blue-light emitting LED die, a cyan-light emitting LED die, or a yellow-light emitting LED die. For example, the two or more associated LED dies may be mounted on a common package. The two or more LED dies may be associated such that their respective light emissions may be combined to produce a desired spectral emission. The two or more LED dies may also be electrically associated with one another (e.g., connected to a common ground).

When a structure (e.g., layer, region) is referred to as being “on”, “over” “overlying” or “supported by” another structure, it can be directly on the structure, or an intervening structure (e.g., layer, region) also may be present. A structure that is “directly on” or “in contact with” another structure means that no intervening structure is present.

The above description is merely illustrative. Having thus described several aspects of at least one embodiment of this invention including the preferred embodiments, it is to be appreciated various alterations, modifications, and improvements will readily occur to those skilled in the art. Such alterations, modifications, and improvements are intended to be part of this disclosure, and are intended to be within the spirit and scope of the invention. Accordingly, the is foregoing description and drawings are by way of example only.

What is claimed is:

1. A method for curing comprising:
providing at least one LED source capable of emitting at least one discrete wavelength;
controlling the individual power and wavelength emitted by the LED source(s); and
exposing a curable substance to the controlled emission of the LED source(s), wherein a desired curing process is achieved.

2. The method of claim 1, further including controlling the duration of the emitted wavelength.

3. The method of claim 1, further including controlling the intensity of the emitted wavelength.

4. The method of claim 3, wherein controlling the intensity is a function of controlling the area and angle of the emitted wavelength.

5. The method of claim 1, wherein the curable substance further includes photo initiators.

6. The method of claim 5, wherein controlling each wavelength emitted by the LED source(s) further includes choosing a particular wavelength as determined by the properties of the photo initiators.

7. The method of claim 1, further including focusing the emitted wavelength(s) onto the curable substance.

8. The method of claim 1, wherein the emitted wavelength is in the range of 400-420 nm.

9. The method of claim 1, wherein the emitted wavelength is in the range of 380-400 nm.

10. The method of claim 1, wherein the emitted wavelength is in the range of 360-380 nm.

11. The method of claim 1, further including accessing a database listing properties of the curable substance.

12. The method of claim 1, wherein the controlled emission is devoid of any optical filters.

13. The method of claim 1, wherein the controlled emission is devoid of any mechanical shutters.

14. The method of claim 1, wherein multiple LED sources form a first array.

15. The method of claim 14, wherein all the LED sources in the first array emit the same wavelength.

16. The method of claim 14, wherein a second array is formed from multiple LED sources.

17. The method of claim 1, further including using a light guide to direct the emission from each LED source to the curable substance.

18. The method of claim 1, further including using a light guide per each LED source to direct the emission from each LED source to the curable substance.

19-26. (canceled)

27. A system for curing a product comprising:
at least one LED source emitting radiation having a first wavelength; and
a controller having the capability to control the power and wavelength of the emission from the LED source(s).

28-57. (canceled)

58. A system for curing a product comprising:
at least one LED source emitting radiation having a first wavelength;
a controller having the capability to control the power and wavelength of the emission from the LED source(s); and
an optical system guiding the emitted radiation from the LED source to a curable product.
